(19) United States
(12) Patent Application Publication
(10) Pub. No.: US 2026/0169913 A1
(43) Pub. Date: Jun. 18, 2026

(54) DATA DECODING DEVICE AND MEMORY SYSTEM

(71) Applicant: Kioxia Corporation, Tokyo (JP)

(72) Inventors: Masato SUMIYOSHI, Yokohama (JP); Keiri NAKANISHI, Kawasaki (JP)

(73) Assignee: Kioxia Corporation, Tokyo (JP)

(21) Appl. No.: 19/317,661

(22) Filed: Sep. 3, 2025

(30) Foreign Application Priority Data
Dec. 16, 2024 (JP) 2024-219748

(51) Int. Cl. G06F 12/02

(52) U.S. Cl. CPC G06F 12/0246; G06F 2212/7206

(57) ABSTRACT

According to one embodiment, a decoding device includes a first memory, a second memory, decoding circuitry, first selection circuitry, and second selection circuitry. The first memory stores a data stream including one or more blocks each including a data portion of a first type and a data portion of a second type. The first selection circuitry switches a transfer destination to which the data portion of the second type is transferred from the first memory. The second selection circuitry switches a transfer source from which the data portion of the second type is transferred to the decoding circuitry.

### CROSS-REFERENCE TO RELATED APPLICATIONS

This application is based upon and claims the benefit of priority from Japanese Patent Application No. 2024-219748, filed Dec. 16, 2024, the entire contents of which are incorporated herein by reference.

### FIELD

Embodiments described herein relate generally to a technique for decoding data.

### BACKGROUND

Entropy coding is a variable-length coding scheme for generating a coding table based on frequencies of occurrence of symbols in a symbol string to be encoded. The coding table indicates a correspondence between a symbol and a code word that is assigned to the symbol. In the entropy coding, a short code word is assigned to a symbol that occurs at a high frequency, and a long code word is assigned to a symbol that occurs at a low frequency. Therefore, each of the symbols to be encoded is converted into a variable-length code by using the coding table.

Compressed data (compressed stream) obtained with the entropy coding includes one or more compression units (CUs). Each of the one or more compression units includes one or more blocks. Each of the one or more blocks includes a header and a payload. The header includes data for restoring a coding table. The payload includes one or more variable-length codes. Each of the one or more variable-length codes is decoded by using the restored coding table. Therefore, for each block, the variable-length codes are decoded by using the restored coding table, and thus, the compressed data can be decompressed.

### BRIEF DESCRIPTION OF THE DRAWINGS

FIG. 1 is a block diagram illustrating an example of a configuration of an information processing system that includes a data decoding device according to an embodiment.

FIG. 2 is a diagram illustrating an example of a data configuration of a compressed stream and a LAST signal that are input to the data decoding device according to the embodiment.

FIG. 3 is a block diagram illustrating a configuration of a data decoding device according to a comparative example.

FIG. 4 is a timing chart illustrating periods in which processes of decoding headers are executed and periods in which processes of decoding payloads are executed, in the data decoding device according to the comparative example.

FIG. 5 is a block diagram illustrating an example of a configuration of the data decoding device according to the embodiment.

FIG. 6 is a flowchart illustrating an example of the procedure of a first process executed in the data decoding device according to the embodiment.

FIG. 7 is a flowchart illustrating an example of the procedure of a second process executed in the data decoding device according to the embodiment.

FIG. 8 is a flowchart illustrating an example of the procedure of a third process executed in the data decoding device according to the embodiment.

FIG. 9 is a timing chart illustrating an example of periods in which processes of decoding headers are executed and periods in which processes of decoding payloads are executed, in the data decoding device according to the embodiment.

### DETAILED DESCRIPTION

In general, according to one embodiment, a data decoding device includes a first memory, first decoding circuitry, a second memory, second decoding circuitry, first selection circuitry, and second selection circuitry. The first memory stores a first data stream that includes one or more first blocks each including a data portion of a first type and a data portion of a second type. The first decoding circuitry decodes the data portion of the first type. The second memory is capable of storing the data portion of the second type. The second decoding circuitry decodes the data portion of the second type. The first selection circuitry switches a transfer destination to which the data portion of the second type is transferred from the first memory. The second selection circuitry switches a transfer source from which the data portion of the second type is transferred to the second decoding circuitry. In a case where a second block among the one or more first blocks is a final block in the first data stream, the first selection circuitry transfers a second data portion of the second type included in the second block from the first memory to the second memory, and the second selection circuitry transfers the second data portion stored in the second memory to the second decoding circuitry.

Various embodiments will be described hereinafter with reference to the accompanying drawings.

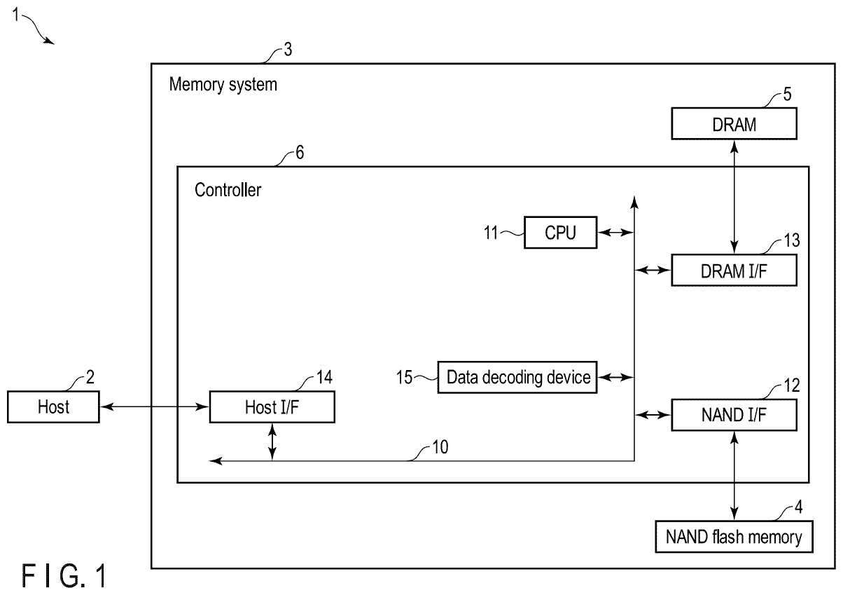

FIG. 1 illustrates an example of a configuration of an information processing system that includes a data decoding device according to an embodiment. The information processing system 1 includes a host device 2 and a memory system 3.

The host device 2 is an information processing device that stores data in the memory system 3. The host device 2 is, for example, a storage server that stores a large amount of various data in the memory system 3 or a personal computer. Hereinafter, the host device 2 is referred to as a host 2.

The memory system 3 is a semiconductor storage device configured to write data into a nonvolatile memory and read data from the nonvolatile memory. The nonvolatile memory is, for example, a NAND flash memory 4. The memory system 3 is implemented as, for example, a solid state drive (SSD). Hereinafter, a case where the memory system 3 is implemented as an SSD including the NAND flash memory 4 will be explained. Note that the memory system 3 may be implemented as another type of storage device such as a hard disk drive (HDD).

The memory system 3 may be used as a storage of the host 2. The memory system 3 may be provided inside the host 2 or may be connected to the host 2 via a cable or a network.

An interface for connecting the host 2 and the memory system 3 conforms to standards such as SCSI, Serial Attached SCSI (SAS), ATA (AT Attachment), Serial ATA (SATA), PCI Express™ (PCIe™), Ethernet™, Fibre channel, and NVM Express™ (NVMe™).

The memory system 3 includes, for example, a NAND flash memory 4, a dynamic random access memory (DRAM) 5, and a controller 6.

The NAND flash memory 4 includes one or more memory chips. Each memory chip includes multiple blocks. The blocks each function as a minimum unit of a data erase operation. The block is also referred to as an erase block or a physical block. Each of the blocks includes multiple pages. Each of the pages includes multiple memory cells that are connected to a single word line. The pages each function as a unit of a data write operation and a data read operation. Note that a word line may also function as a unit of a data write operation and a data read operation.

The tolerable maximum number of program/erase cycles (maximum number of P/E cycles) for each of the blocks is limited. One P/E cycle of a block includes a data erase operation to erase data stored in all memory cells in the block and a data write operation to write data in each page of the block.

The DRAM 5 is a volatile memory. The storage area of the DRAM 5 is allocated as, for example, a storage area of firmware (FW), a cache area of a logical-to-physical address translation table, and a buffer area of user data. The user data is data requested to be stored in the memory system 3 by the host 2 and transmitted from the host 2. The user data stored in the buffer area includes, for example, user data to be written into the NAND flash memory 4 and user data read from the NAND flash memory 4. The user data to be written into the NAND flash memory 4 may be written into the NAND flash memory 4 after being compressed. In addition, the user data read from the NAND flash memory 4 may be compressed user data and be decompressed.

An interface for connecting the DRAM 5 and an external component (e.g., a data decoding device 15) conforms to, for example, the Advanced eXtensible Interface 4-Stream (AXI4-Stream) standard. The interface conforming to AXI4-Stream uses, for example, signals for controlling start of data transfer (VALID signal and READY signal), a signal for transferring data (DATA signal), and a signal indicative of last data (LAST signal). For these signals, for example, respective signal lines are provided.

The controller 6 is a memory controller configured to control the NAND flash memory 4 and the DRAM 5. The controller 6 is implemented with circuitry such as a System-on-a-Chip (SoC).

The controller 6 functions as, for example, a flash translation layer (FTL) configured to execute data management and block management of the NAND flash memory 4. The data management executed by the FTL includes (1) management of mapping data indicative of a relationship between each logical address and each physical address of the NAND flash memory 4, and (2) a process to hide a difference between data read/data write operations in units of page and data erase operations in units of block. The block management includes management of defective blocks, wear leveling, and garbage collection.

The logical address is used by the host 2 for addressing a storage area of the memory system 3. The logical address is, for example, a logical block address (LBA).

The management of mapping between each logical address and each physical address is executed, for example, by using the logical-physical address translation table. The controller 6 uses the logical-to-physical address translation table to manage the mapping between each logical address and each physical address with a certain management size. A physical address corresponding to a logical address indicates a physical memory location in the NAND flash memory 4 to which data of the logical address is written. The logical-to-physical address translation table may be loaded from the NAND flash memory 4 to the DRAM 5 when the memory system 3 is boot up.

The data write operation into one page is executable only once in a single P/E cycle. Thus, the controller 6 writes updated data corresponding to a logical address not to an original physical memory location in which previous data corresponding to the logical address is stored but to a different physical memory location. Then, the controller 6 updates the logical-to-physical address translation table to associate the logical address with this different physical memory location and to invalidate the previous data.

The controller 6 includes, for example, a CPU 11, a NAND interface (NAND I/F) 12, a DRAM interface (DRAM I/F) 13, a host interface (host I/F) 14, and the data decoding device 15. The CPU 11, the NAND I/F 12, the DRAM I/F 13, the host I/F 14, and the data decoding device 15 are connected to each other via, for example, a bus 10.

The controller 6 may include a static random access memory (SRAM) or a DRAM. In this case, the DRAM 5 outside the controller 6 does not need to be provided.

The SRAM is a volatile memory. A storage area of the SRAM may be allocated as, for example, at least one of a storage area of the FW, a cache area of the logical-to-physical address translation table, and a buffer area of user data.

The CPU 11 is a processor configured to control the NAND I/F 12, the DRAM I/F 13, the host I/F 14, and the data decoding device 15. The CPU 11 performs various processes by executing the FW loaded from the NAND flash memory 4 to the DRAM 5. The FW is a control program including instructions for causing the CPU 11 to perform the various processes. The CPU 11 performs, in addition to the above-described processes of FTL, command processes to process various commands received from the host 2. The operation of the CPU 11 is controlled by the FW executed by the CPU 11. Note that part of or the entire FTL processes and command processes may be executed by dedicated hardware in the controller 6.

The NAND I/F 12 electrically connects the controller 6 and the NAND flash memory 4 to each other. The NAND I/F 12 conforms to an interface standard such as a Toggle DDR and an Open NAND Flash Interface (ONFI).

The NAND I/F 12 functions as NAND control circuitry configured to control the NAND flash memory 4. The NAND I/F 12 may be connected to a plurality of memory chips in the NAND flash memory 4 via a plurality of channels. By operating the plurality of memory chips in parallel, it is possible to broaden an access bandwidth between the controller 6 and the NAND flash memory 4.

The DRAM I/F 13 functions as DRAM control circuitry configured to control access to the DRAM 5.

The host I/F 14 is circuitry that functions as an interface for performing communication between the memory system 3 and the host 2. The host I/F 14 includes circuitry that receives various commands (e.g., an input/output (I/O) command and a control command) and data from the host 2. The I/O command is, for example, a read command or a write command. The control command is, for example, an unmap command (trim command) or a format command. The host I/F 14 includes circuitry that transmits a response to a command and data to the host 2.

The data decoding device 15 is a decompressor that decompresses (decodes) a compressed stream. The compressed stream is also referred to as compressed data. The compressed stream is, for example, data transmitted from the host 2 to the memory system 3 or data read from the NAND flash memory 4. For example, when having received a read command from the host 2, the CPU 11 stores, in the DRAM 5, the compressed stream read from the NAND flash memory 4. A direct memory access controller (DMAC) inputs data stored in the DRAM 5 to the data decoding device 15 by data transfer with DMA. For example, the DMAC is included in the controller 6 and controls data transfer between components in the memory system 3 (e.g., data transfer from the DRAM 5 to the data decoding device 15). Note that the CPU 11 may read the compressed stream stored in the DRAM 5 and input the read compressed stream to the data decoding device 15. In addition, the data decoding device 15 may read the compressed stream stored in the DRAM 5. Then, the data decoding device 15 decompresses the input (read) compressed stream, thereby generating decompressed data (decoded data). More specifically, the data decoding device 15 decompresses the compressed stream for each compression unit (CU). The compression unit is a unit of data compressed at a time.

When a compressed stream is stored in the NAND flash memory 4, a predetermined process such as an error correction process or a randomization process may be executed. In this case, the CPU 11 writes data obtained by executing the predetermined process on the compressed stream, into the NAND flash memory 4 via the NAND I/F 12. That is, the CPU 11 writes the data based on the compressed stream into the NAND flash memory 4. Here, the controller 6 may include a compression circuit, and the compressed stream may be data compressed by the compression circuit of the controller 6. In this case, when reading a compressed stream from the NAND flash memory 4, the CPU 11 reads data based on a read command from the host 2, from the NAND flash memory 4 via the NAND I/F 12. The data read from the NAND flash memory 4 is stored in the DRAM 5 by the CPU 11 as a compressed stream, after a predetermined process such as an error correction process and a randomization restoration process is executed on the data. The compressed stream stored in the DRAM 5 is input to the data decoding device 15 by the CPU 11. The data decoding device 15 decompresses the input compressed stream, thereby generating decompressed data (decoded data). That is, the data decoding device 15 decompresses the compressed stream based on the data read from the NAND flash memory 4, thereby generating the decompressed data (decoded data).

Note that, in a case where the data decoding device 15 reads a compressed stream from the DRAM 5, the DRAM 5 outputs the compressed stream per compression unit as DATA signals to the data decoding device 15 via the DRAM I/F 13 when start of data transfer to the data decoding device 15 has been enabled by using a VALID signal and a READY signal, for example. Then, the DRAM 5 outputs a LAST signal indicative of the end of the transfer of the compressed stream per compression unit at the timing when the last data in the compressed stream per compression unit is output. That is, the LAST signal represents the end of the compressed stream per compression unit. As a result, the data decoding device 15 can read the compressed stream from the DRAM 5 for each compression unit. A compressed stream may include a plurality of compression units. When a compressed stream includes a plurality of compression units, the LAST signal represents the end of the compressed stream that includes the plurality of compression units. The DRAM 5 outputs the LAST signal at the timing when the transfer of the last compression unit (more specifically, the last data in the last compression unit) among the plurality of compression units included in the compressed stream is completed. Hereinafter, a case where the DRAM 5 outputs the compressed stream per compression unit and then outputs the LAST signal to the data decoding device 15 will be mainly exemplified.

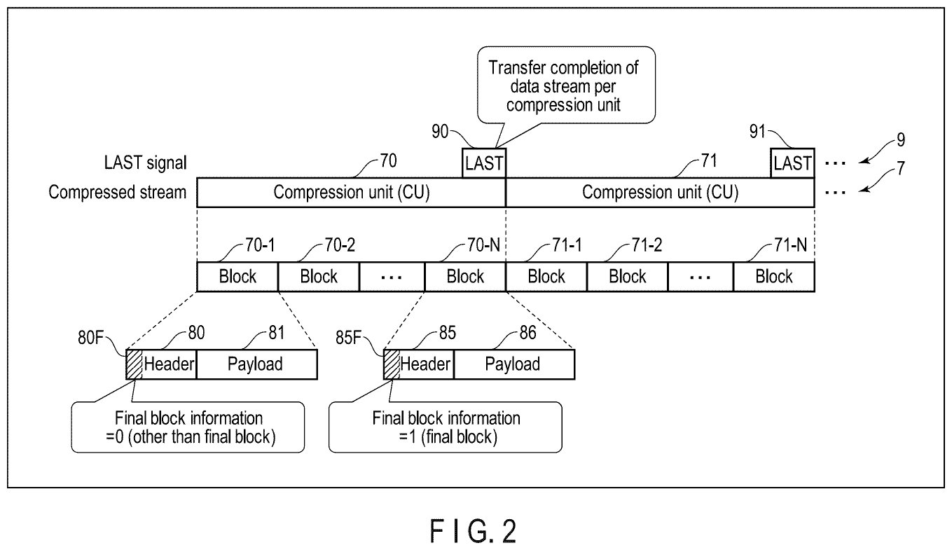

FIG. 2 illustrates an example of a data configuration of a compressed stream and a LAST signal that are input to the data decoding device 15.

A compressed stream 7 is, for example, a data stream transferred from a specific storage area to the data decoding device 15. The specific storage area is, for example, the DRAM 5. The compressed stream 7 includes, for example, data compressed by using entropy coding. Note that the compressed stream 7 may be data compressed by using entropy encoding after any process such as dictionary-based compression is performed. That is, data on which entropy coding is to be executed may be data instructed to be written by the host 2, or may be data instructed to be written on which the process such as dictionary-based compression has been executed. Specifically, the compressed stream 7 includes one or more compressed streams per compression unit (CU) 70, 71, . . . , in order from the head. Each of the compressed streams per compression unit 70, 71, . . . is data obtained by compressing uncompressed data per compression unit by using entropy coding (e.g., data compressed with entropy coding after dictionary-based compression). The compressed stream per compression unit is also simply referred to as a compression unit.

Note that the dictionary-based compression is a coding scheme in which data to be compressed is converted into a pointer by using a history buffer that stores data (i.e., symbol string) in the past. The dictionary-based compression is also referred to as dictionary-based coding. The pointer includes, for example, a match distance and a match length. In the dictionary-based compression, the history buffer is searched to acquire past data that matches at least a part of the data to be compressed, and a match distance and a match length are obtained. The match distance is a distance from a position where the data to be compressed is to be stored to a position where the acquired past data is stored in the history buffer. The match length is the length of a matching portion between the acquired past data and the data to be compressed. In the dictionary-based compression, the data to be compressed is converted into the pointer (that is, the match distance and the match length) and thus the data can be compressed.

Each of the compression units 70, 71, . . . includes, for example, one or more blocks. Specifically, the compression unit 70 includes, for example, one or more blocks 70-1, 70-2, . . . , and 70-N. The compression unit 71 includes, for example, one or more blocks 71-1, 71-2, . .. , and 71-N.

Each block includes a header and a payload. In the block, the header and the payload are arranged in order.

The header is a data portion of a first type that includes data (information) for decoding the payload. Specifically, the header includes final block information and data for restoring a coding table.

The final block information is information (flag) indicating whether a corresponding block is the final block included in a compression unit. The final block information corresponds to, for example, a BFINAL field defined in the DEFLATE standard. When the corresponding block is the final block included in the compression unit, the final block information indicates, for example, “1”. When the corresponding block is not the final block included in the compression unit, the final block information indicates, for example, “0”. Note that the value indicating that the corresponding block is the final block included in the compression unit and the value indicating that the corresponding block is not the final block included in the compression unit may be set freely.

The coding table is information indicative of correspondence between one or more symbols and one or more code words (variable length codes) that are assigned to the one or more symbols, respectively. A code word is converted (decoded) into a symbol by using the restored coding table. The restored coding table is also referred to as a decoding table.

The payload is a data portion of a second type that includes data to be decoded (i.e., encoded data). The data to be decoded includes, for example, a code word converted from a symbol with entropy coding.

In the example illustrated in FIG. 2, the leading block 70-1 included in the compression unit includes a header 80 and a payload 81. For example, final block information 80F is arranged at the beginning of the header 80. The final block information 80F corresponds to the leading block 70-1. Therefore, a value indicating that the block 70-1 is not the final block (e.g., 0) is set in the final block information 80F.

Furthermore, the final block 70-N included in the compression unit 70 includes a header 85 and a payload 86. For example, final block information 85F is arranged at the beginning of the header 85. The final block information 85F corresponds to the final block 70-N. Therefore, a value indicating that the block 70-N is the final block (e.g., 1) is set in the final block information 85F.

Note that, at a timing when the last data included in each of the compression units 70, 71, . . . is transferred (that is, at a timing when the transfer of each compression unit ends), a LAST signal 9 that represents the end of each compression unit is input to the data decoding device 15. In the example illustrated in FIG. 2, a LAST signal 90 is input to the data decoding device 15 at the timing when the last data included in the compression unit 70 is transferred. Furthermore, a LAST signal 91 is input to the data decoding device 15 at the timing when the last data included in the compression unit 71 is transferred. By inputting the LAST signal 9, the data decoding device 15 can detect the end of the transfer of the corresponding compression unit.

Based on the data configuration of the compressed stream 7 and the LAST signal 9 described above, the data decoding device 15 decompresses the compressed stream 7. Note that the data configuration of the compressed stream 7 and the LAST signal 9 illustrated in FIG. 2 are examples. The data configuration of the compressed stream 7 and the LAST signal 9 may be replaced with any configuration as long as the data decoding device 15 is capable of detecting the end of each of the one or more compression units and the final block included in each compression unit. Hereinafter, one of the compressed streams per compression unit 70, 71, . . . that is not specified will also be referred to as a compressed stream 7 per compression unit.

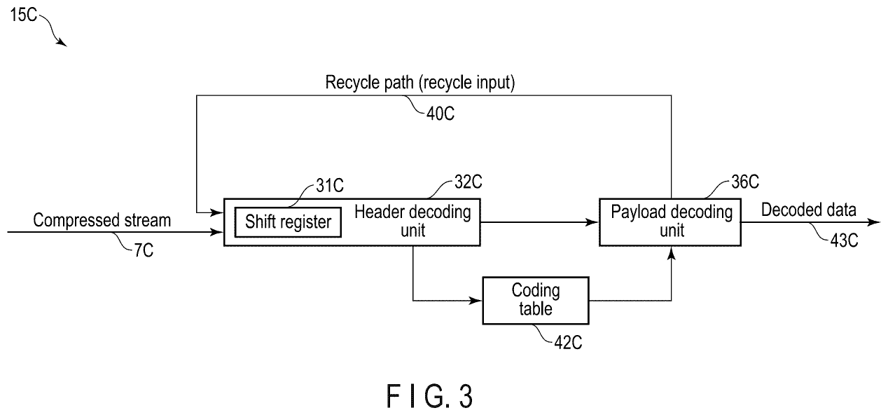

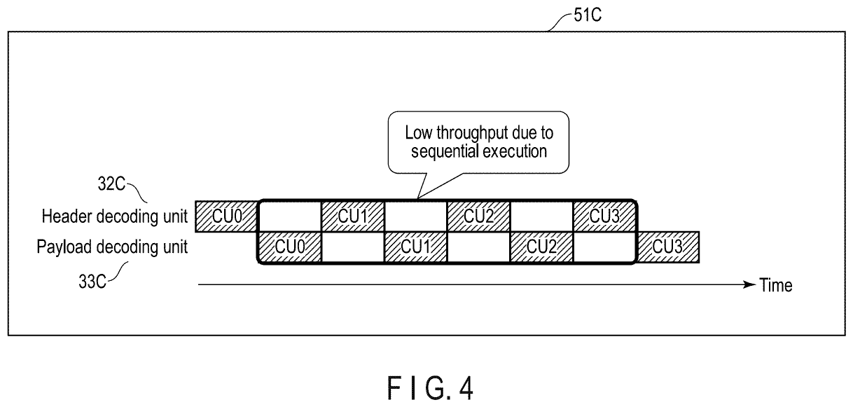

Here, a data decoding device 15C according to a comparative example will be described with reference to FIGS. 3 and 4.

FIG. 3 is a block diagram illustrating a configuration of the data decoding device 15C according to the comparative example. The data decoding device 15C is a device that decodes a compressed stream 7C input from the outside and outputs decoded data 43C obtained by the decoding. The data decoding device 15C includes a header decoding unit 32C and a payload decoding unit 36C.

The header decoding unit 32C includes a shift register 31C. The shift register 31C stores the compressed stream 7C.

The header decoding unit 32C reads, from the shift register 31C, the compressed stream 7C in order from the beginning. The header decoding unit 32C acquires a header of a current block from the read data. The header decoding unit 32C restores a coding table 42C by using data included in the header. The header decoding unit 32C outputs the coding table 42C to the payload decoding unit 36C. Furthermore, the header decoding unit 32C sequentially outputs a data stream in the compressed stream 7C that is subsequent to the header, to the payload decoding unit 36C via a pipeline (decoding pipeline) from the header decoding unit 32C to the payload decoding unit 36C.

The payload decoding unit 36C decodes the data stream received via the decoding pipeline by using the coding table 42C, thereby generating one or more symbols. Then, the payload decoding unit 36C outputs decoded data 43C including the one or more symbols.

More specifically, the payload decoding unit 36C converts, into a symbol, the data stream received via the decoding pipeline in order from the beginning by using the coding table 42C. Then, the payload decoding unit 36C detects a boundary between the current block and the next block, based on the fact that the symbol obtained by the conversion is an end of block (EOB) symbol. The EOB symbol is a symbol indicative of the end of a corresponding block.

In this manner, an inter-block boundary in the compressed stream 7C is detected in response to generation of an EOB symbol by the payload decoding unit 36C. Therefore, the data stream output from the header decoding unit 32C to the payload decoding unit 36C via the decoding pipeline may include a header of the next block.

When having received a data stream subsequent to a payload of the current block, the payload decoding unit 36C inputs the received data stream back to the header decoding unit 32C via a recycle path 40C (recycle input). As a result, the header decoding unit 32C and the payload decoding unit 36C can start a process of decoding the next block.

In the process of decoding in the data decoding device 15C of the comparative example, for example, when the compressed stream 7C is decoded for each compression unit, the boundary between the final block included in the current compression unit and the leading block (i.e., the first block) included in the next compression unit (i.e., an EOB symbol) is detected by executing the process of decoding the payload, and then the process of decoding a header of the leading block is started. Therefore, in the data decoding device 15C, while the process of decoding a payload of the final block included in the current compression unit is executed, a process of decoding a header of the leading block included in the next compression unit is not executed. That is, in the data decoding device 15C, the process of decoding the payload of the final block included in the current compression unit and the process of decoding the header of the leading block included in the next compression unit cannot be executed in parallel. Therefore, in the data decoding device 15C, the data decoding throughput (decoding efficiency) decreases.

FIG. 4 is a timing chart illustrating periods in which processes of decoding headers are executed and periods in which processes of decoding payloads are executed, in the data decoding device 15C according to the comparative example. In the timing chart 51C, the horizontal axis indicates time. Here, it is assumed that one compression unit (CU) includes one block. In the timing chart 51C, a period in which a header included in each compression unit is decoded by the header decoding unit 32C and a period in which a payload included in each compression unit is decoded by the payload decoding unit 36C are illustrated along the passage of time.

In the data decoding device 15C, a process of decoding a header by the header decoding unit 32C and a process of decoding a payload by the payload decoding unit 36C are alternately executed. Specifically, in the data decoding device 15C, a process of decoding a header included in a compression unit CU0, a process of decoding a payload included in the compression unit CU0, a process of decoding a header included in a compression unit CU1, a process of decoding a payload included in the compression unit CU1, a process of decoding a header included in a compression unit CU2, a process of decoding a payload included in the compression unit CU2, a process of decoding a header included in a compression unit CU3, and a process of decoding a payload included in the compression unit CU3 are sequentially executed.

In this manner, in the data decoding device 15C, a process of decoding a payload included in a current compression unit (e.g., the process of decoding the payload included in the compression unit CU0) and a process of decoding a header included in the next compression unit (e.g., the process of decoding the header included in the compression unit CU1) are not executed at an overlapping time (that is, in parallel). In other words, in the data decoding device 15C, the process of decoding the header included in each compression unit is intermittently executed, and the process of decoding the payload included in each compression unit is intermittently executed. Therefore, the data decoding device 15C has a low throughput of decoding the compressed stream 7C.

In contrast, the data decoding device 15 according to the present embodiment is configured to execute (A) a process of decoding a payload of a block (e.g., the final block) included in a current compression unit and (B) a process of decoding a header of a block (e.g., the leading block) included in the next compression unit, in an at least partially overlapping manner. Specifically, for example, when the payload of the final block included in the current compression unit is to be decoded, the data decoding device 15 transfers the payload from a first memory in which the compressed stream 7 per compression unit is stored to a second memory. As a result, the next compressed stream 7 per compression unit is written to the first memory.

The configuration of the data decoding device 15 is based on the premises that (a) a boundary between the final block included in the current compression unit and the leading block included in the next compression unit to be input can be determined by an external signal (e.g., a LAST signal 9), and (b) the payload of the final block included in the compression unit is not followed by a header included in the same compression unit, and thus, there is no need to accurately extract the beginning of the header from the compressed stream 7. On the premises (a) and (b), in decoding the payload of the final block, there is no need to perform an operation of shifting the compressed stream 7 in accordance with a consumed code amount corresponding to a generated symbol. The consumed code amount corresponding to a symbol is the data amount of a code word used for generating the symbol. Therefore, the data decoding device 15 stores, in the second memory, the payload of the final block before being decoded, and then decodes the payload of the final block. When the payload of the final block has been stored in the second memory, the data decoding device 15 stores the next compression unit in the first memory. As a result, the data decoding device 15 is capable of starting to decode a header of the leading block included in the next compression unit.

Thus, for example, the data decoding device 15 can overlap (A) execution of a process of decoding the payload of the final block included in the current compression unit read from the second memory and (B) execution of a process of decoding the header of the leading block included in the next compression unit read from the first memory, at least partially. Therefore, the data decoding device 15 can improve the throughput of decoding (decompressing) the compressed stream 7 as compared with the data decoding device 15C of the comparative example.

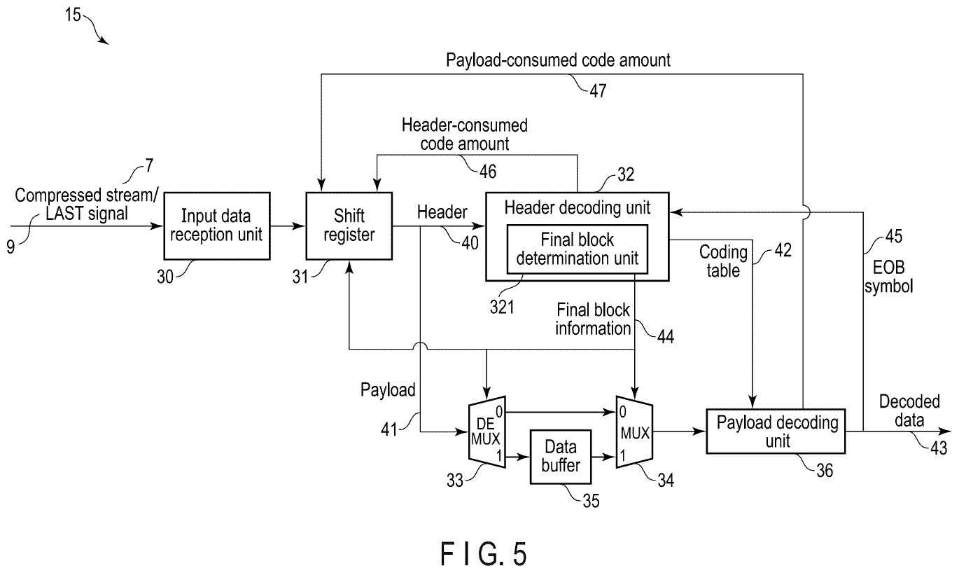

FIG. 5 is a block diagram illustrating an example of a configuration of the data decoding device 15. For example, a compressed stream 7 and a LAST signal 9 that represents the end of the compressed stream 7 per compression unit are input to the data decoding device 15. The data decoding device 15 decodes the compressed stream 7 and outputs decoded data 43.

The data decoding device 15 includes, for example, an input data reception unit 30, a shift register 31, a header decoding unit 32, a demultiplexer (DEMUX) 33, a multiplexer (MUX) 34, a data buffer 35, and a payload decoding unit 36.

The components of the data decoding device 15, such as the input data reception unit 30, the shift register 31, the header decoding unit 32, the DEMUX 33, the MUX 34, the data buffer 35, and the payload decoding unit 36, are implemented with, for example, at least one of a register, a memory, an adder, a multiplier, a selector, and other arithmetic units. The register is implemented with, for example, a sequential circuit such as a flip-flop. The memory is implemented with, for example, a memory element such as an SRAM or a DRAM. The adder, the multiplier, the selector, and the other arithmetic units are implemented with, for example, a combinational logic circuit.

The input data reception unit 30 receives data input (provided) from the outside. The received data includes, for example, a compressed stream 7 and a LAST signal 9. Specifically, the input data reception unit 30 receives a compressed stream 7 per compression unit until receiving a LAST signal 9 that represents the end of the compressed stream 7 per compression unit. Note that the input data reception unit 30 may receive an uncompressed data stream per specific unit instead of the compressed stream 7 per compression unit until receiving a LAST signal 9 that represents the end of the uncompressed data stream. The input data reception unit 30 sequentially stores the received compressed stream 7 per compression unit (alternatively, the uncompressed data stream per specific unit) in the shift register 31. Hereinafter, a case where data input from the outside is a compressed stream 7 per compression unit and a LAST signal 9 that represents the end of the compressed stream 7 per compression unit will be mainly described.

The input data reception unit 30 prohibits (stops) writing of data to the shift register 31 when having stored the compressed stream 7 per compression unit up to its end in the shift register 31. Specifically, on the basis of the reception of the LAST signal 9, the input data reception unit 30 determines that, in the shift register 31, the compressed stream 7 per compression unit has been stored up to its end. Then, the input data reception unit 30 sets a write permission/prohibition state of the shift register 31 to prohibition (that is, changes from permission to prohibition). The write permission/prohibition state of the shift register 31 indicates whether writing of data to the shift register 31 is permitted or prohibited.

In addition, the input data reception unit 30 resumes writing of data to the shift register 31 when a payload 41 that belongs to the final block of the compressed stream 7 per compression unit has been stored in the data buffer 35. Specifically, the input data reception unit 30 resumes writing of data to the shift register 31 when the write permission/prohibition state of the shift register 31 has been set to permission. As a result, the input data reception unit 30 can start a process for storing the next compressed stream 7 per compression unit in the shift register 31.

The shift register 31 is a memory that stores data. The shift register 31 is, for example, a sequential circuit that includes a plurality of flip-flops connected sequentially. The data capacity of the shift register 31 is, for example, smaller than the data size of the compression unit. The shift register 31 performs a shift operation of shifting data stored in each flip-flop and storing new data, thereby storing at least a part of the compressed stream 7 per compression unit received by the input data reception unit 30. In other words, the shift register 31 performs the shift operation to discard old data that has been previously stored and to store new data.

The header decoding unit 32 decodes a header 40 of each block included in the compressed stream 7. Specifically, the header decoding unit 32 reads, from the shift register 31, a header 40 of one block (hereinafter, also referred to as a current block) included in the compressed stream 7. The header decoding unit 32 decodes the read header 40, thereby restoring a coding table 42. The header decoding unit 32 outputs the restored coding table 42 to the payload decoding unit 36. The coding table 42 is used for decoding a payload 41 included in the current block.

Here, the operation of the header decoding unit 32 reading the header 40 from the shift register 31 will be specifically explained. The header decoding unit 32 sequentially reads data (data stream) from the shift register 31. The read data is at least a part of the header 40. The header decoding unit 32 refers to one or more fields included in the read data that indicate a configuration of the header 40, thereby dynamically determining the overall size of the header 40 to be read. The header decoding unit 32 reads, from the shift register 31, data of the determined size, which includes the already read data. Alternatively, the header decoding unit 32 reads data from the shift register 31 until the end of data used for restoring the coding table 42 is detected. By reading data from the shift register 31 in this manner, the header decoding unit 32 acquires a data portion corresponding to the header 40. As a result, the header decoding unit 32 can decode the header 40 of the current block.

The header decoding unit 32 notifies the shift register 31 of the size of the data 46 that has been read as the header 40 (hereinafter, also referred to as the header-consumed code amount 46). The header decoding unit 32 may successively notify the shift register 31 of the size of data that has been determined to be part of the header 40 and that has been read from the shift register 31. In the shift register 31, while the current compressed stream 7 per compression unit is being input from the outside, a shift operation is performed based on the notified header-consumed code amount 46. Accordingly, in the shift register 31, while old data that has been previously stored is discarded, new data is stored.

In addition, the header decoding unit 32 includes a final block determination unit 321.

The final block determination unit 321 acquires final block information 44 from the header 40. The final block information 44 indicates whether the current block to which the header 40 belongs is the final block in the current compressed stream 7 per compression unit. Based on the acquired final block information 44, the final block determination unit 321 determines whether the current block is the final block in the current compressed stream 7 per compression unit. Furthermore, for example, the final block determination unit 321 outputs the final block information of the block to the shift register 31, the DEMUX 33, and the MUX 34 until transfer of the payload 41 belonging to the block from the shift register 31 to a transfer destination is completed. In the following description, the final block information indicates “1” when the corresponding block is the final block, and indicates “0” when the corresponding block is not the final block.

In a case where the current block is the final block in the current compressed stream 7 per compression unit, when a header 40 of the leading block in the next compressed stream 7 per compression unit has been written to the shift register 31, the header decoding unit 32 starts a process for decoding the header 40.

The DEMUX 33 is selection circuitry that switches a transfer destination to which a payload 41 is transferred from the shift register 31 in accordance with the final block information 44 output by the final block determination unit 321.

When the final block information indicates that the current block is not the final block (“0” in FIG. 5), the DEMUX 33 selects the MUX 34 as the destination to which the payload 41 is transferred. That is, the DEMUX 33 outputs (transfers) the payload 41 read from the shift register 31 to the MUX 34.

When the final block information indicates that the current block is the final block (“1” in FIG. 5), the DEMUX 33 selects the data buffer 35 as the destination to which the payload 41 is transferred. That is, the DEMUX 33 stores (transfers) the payload 41 read from the shift register 31 to the data buffer 35. Specifically, the DEMUX 33 reads data up to the end of the compressed stream 7 per compression unit stored in the shift register 31 as the payload 41 belonging to the current block. Then, the DEMUX 33 writes the read payload to the data buffer 35. As a result, the payload 41 of the final block is saved in the data buffer 35. Note that the payload 41 of the final block may include data other than code words to be decoded.

The MUX 34 is selection circuitry that switches a transfer source from which a payload 41 is transferred to the payload decoding unit 36 in accordance with the final block information 44 output by the final block determination unit 321.

When the final block information indicates that the current block is not the final block (“0” in FIG. 5), the MUX 34 selects the DEMUX 33 as the transfer source from which the payload 41 is transferred. Then, the MUX 34 outputs, to the payload decoding unit 36, the payload 41 output by the DEMUX 33. In other words, when the final block information indicates that the current block is not the final block, the payload decoding unit 36 reads the payload 41 from the shift register 31 via the DEMUX 33 and the MUX 34.

When the final block information indicates that the current block is the final block (“1” in FIG. 5), the MUX 34 selects the data buffer 35 as the transfer source from which the payload 41 is transferred. Then, the MUX 34 outputs the payload 41 stored in the data buffer 35 to the payload decoding unit 36. In other words, when the final block information indicates that the current block is the final block, the payload decoding unit 36 reads the payload 41 from the data buffer 35 via the MUX 34.

In this manner, when the final block information indicates that the current block is not the final block, a path from the DEMUX 33 to the MUX 34 is enabled. On the other hand, when the final block information indicates that the current block is the final block, a path from the DEMUX 33 to the MUX 34 via the data buffer 35 is enabled.

The data buffer 35 is a memory capable of temporarily storing a payload 41. The data buffer 35 is, for example, a volatile memory such as a first-in first-out (FIFO) memory. Specifically, the data buffer 35 stores the payload 41 of the final block read from the shift register 31 and written to the data buffer 35 by the DEMUX 33. The payload 41 of the final block stored in the data buffer 35 is read and output to the payload decoding unit 36 by the MUX 34.

The payload decoding unit 36 decodes a payload 41 of each block included in the compressed stream 7. Specifically, the payload decoding unit 36 receives the coding table 42 corresponding to the current block from the header decoding unit 32. Further, the payload decoding unit 36 receives the payload 41 belonging to the current block from the MUX 34. The payload decoding unit 36 decodes (converts) one or more code words included in the payload 41 into one or more symbols, respectively, by using the coding table 42. Then, the payload decoding unit 36 outputs decoded data 43 that includes the one or more symbols obtained by the decoding.

In addition, the payload decoding unit 36 outputs the one or more symbols obtained by the decoding to the header decoding unit 32. When one of the symbols received from the payload decoding unit 36 is an EOB symbol 45, the header decoding unit 32 starts a process of decoding a header 40 of the next block. In this case, the next block is a block subsequent to the current block, in the current compressed stream 7 per compression unit.

Note that, in a case where a payload included in an uncompressed data stream has been received instead of a payload 41 included in the compressed stream 7, the payload decoding unit 36 outputs symbols included in the uncompressed data stream as decoded data 43 as they are. In addition, the payload decoding unit 36 outputs the symbols included in the uncompressed data stream to the header decoding unit 32 as they are. The header decoding unit 32 detects the end of a block corresponding to the symbols decoded by the payload decoding unit 36, based on information on the number of symbols that is included in the header 40.

Here, an operation of the payload decoding unit 36 receiving a payload 41 will be described in more detail.

When the current block is not the final block, the payload decoding unit 36 sequentially receives data (data stream) read from the shift register 31 via the DEMUX 33 and the MUX 34. The received data is at least a portion of the payload 41. The payload decoding unit 36 decodes a code word included in the received data into a symbol by using the coding table 42. When the symbol obtained by the decoding is an EOB symbol 45, the payload decoding unit 36 finishes receiving the payload 41 belonging to the current block. That is, by reading data from the shift register 31 until the EOB symbol 45 is acquired, the payload decoding unit 36 acquires a data portion corresponding to the payload 41 of the current block. As a result, the payload decoding unit 36 can decode the payload 41 of the current block.

When the current block is the final block, the payload decoding unit 36 receives the payload 41 of the final block read from the data buffer 35 via the MUX 34. The payload decoding unit 36 may sequentially receive data (data stream) included in the payload 41 of the final block from the beginning. The payload decoding unit 36 decodes a code word included in the received payload 41 into a symbol by using the coding table 42. As a result, the payload decoding unit 36 can decode the payload 41 of the final block. After the payload decoding unit 36 receives the entire payload 41 of the final block, the data stored in the data buffer 35 may be discarded.

In addition, when the current block is not the final block, the payload decoding unit 36 notifies the shift register 31 of the size of the data 47 that has been read as the payload 41 (hereinafter, also referred to as the payload-consumed code amount 47). The payload decoding unit 36 may successively notify the shift register 31 of the size of a part of the payload 41 that has been decoded. In the shift register 31, while the current compressed stream 7 per compression unit is being input from the outside, a shift operation is performed based on the notified payload-consumed code amount 47. Accordingly, in the shift register 31, while old data that has been previously stored is discarded, new data is stored.

When the current block is the final block, the payload decoding unit 36 may not notify the shift register 31 of the payload-consumed code amount 47. This is because a boundary between the final block included in the current compression unit and the leading block included in the next compression unit is identifiable by a signal from the outside (e.g., a LAST signal 9). That is, the shift register 31 can perform a shift operation of discarding data included in the current compression unit and storing data included in the next compression unit, for example, based on the LAST signal 9.

With the configuration described above, the data decoding device 15 decodes the header 40 and the payload 41 that belong to each block included in the compressed stream 7, thereby decompressing the compressed stream 7. Specifically, the header decoding unit 32 restores the coding table 42 and obtains the final block information 44 by analyzing the header 40. The payload decoding unit 36 decodes a code word included in the payload 41 into a symbol by using the coding table 42.

In addition, the DEMUX 33 stores, in the data buffer 35, the payload 41 of the final block in the current compressed stream 7 per compression unit. As a result, the next compressed stream 7 per compression unit is stored in the shift register 31. When the header 40 of the leading block in the next compressed stream 7 per compression unit has been written in the shift register 31, the header decoding unit 32 starts a process of decoding the header 40.

Thus, in the data decoding device 15, (A) the process of decoding the payload 41 of the final block in the current compressed stream 7 per compression unit executed by the payload decoding unit 36 and (B) the process of decoding the header 40 of the leading block in the next compressed stream 7 per compression unit executed by the header decoding unit 32 can overlap (can be in parallel) at least partially. Therefore, the data decoding device 15 can improve the decoding throughput, as compared with the data decoding device 15C of the comparative example in which the payload decoding unit 36C completes the process of decoding the payload of the final block in the current compressed stream 7C per compression unit, and then the header decoding unit 32C starts the process of decoding the leading block in the next compressed stream 7C per compression unit.

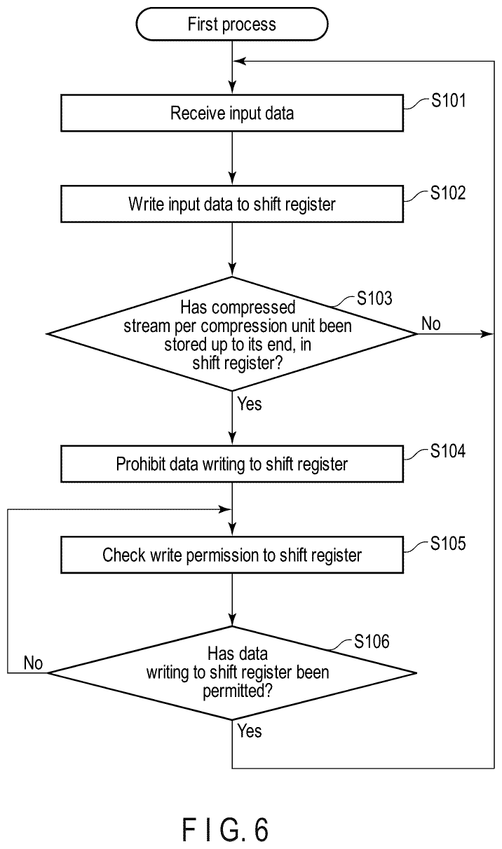

Next, processes executed in the data decoding device 15 will be described with reference to FIGS. 6 to 8.

FIG. 6 is a flowchart illustrating an example of the procedure of a first process executed in the data decoding device 15. The first process is a process of controlling writing (storing) of data to the shift register 31. The input data reception unit 30 executes the first process, for example, in a case where there is a compressed stream 7 to be decoded. The compressed stream 7 to be decoded is stored in, for example, the DRAM 5.

First, the input data reception unit 30 receives input data (step S101). The input data is, for example, at least a part of the compressed stream 7 transferred from the DRAM 5 to the data decoding device 15. The input data reception unit 30 writes the received input data to the shift register 31 (step S102).

The input data reception unit 30 determines whether the compressed stream 7 per compression unit has been stored up to its end in the shift register 31 (step S103). Specifically, the input data reception unit 30 determines whether the compressed stream 7 per compression unit is stored up to its end in the shift register 31, for example, based on a LAST signal 9 defined in the AXI4-Stream interface standard. The input data reception unit 30 determines that the compressed stream 7 per compression unit is stored up to its end in the shift register 31, for example, based on the LAST signal 9 that has become “1”. In addition, the input data reception unit 30 determines that the compressed stream 7 per compression unit is not stored up to its end in the shift register 31, for example, based on the LAST signal being “0”.

When the compressed stream 7 per compression unit has not been stored up to its end in the shift register 31 (No in step S103), the input data reception unit 30 returns to step S101. That is, the input data reception unit 30 continues to receive input data and write the input data to the shift register 31.

When the compressed stream 7 per compression unit has been stored up to its end in the shift register 31 (Yes in step S103), the input data reception unit 30 prohibits writing of data to the shift register 31 (step S104). That is, the input data reception unit 30 sets the write permission/prohibition state of the shift register 31 to prohibition. Accordingly, new input data (e.g., the next compressed stream 7 per compression unit) is not written in the shift register 31.

Next, the input data reception unit 30 checks the write permission/prohibition state of the shift register 31 (step S105). The write permission/prohibition state of the shift register 31 is changed from prohibition to permission, for example, in response to a notification of write permission by the header decoding unit 32 (more specifically, the final block determination unit 321). Note that the shift register 31 may change the write permission/prohibition state to permission when the final block information 44 indicative of the final block in the current compressed stream 7 per compression unit has been input from the header decoding unit 32 to the shift register 31 and the payload 41 of the final block has been read from the shift register 31 (that is, has been transferred to the data buffer 35). Then, the input data reception unit 30 determines whether writing of data to the shift register 31 has been permitted (step S106).

When writing of data to the shift register 31 is prohibited (No in step S106), the input data reception unit 30 returns to step S105. That is, the input data reception unit 30 repeats the process of steps S105 and S106 until writing of data to the shift register 31 is permitted.

When writing of data to the shift register 31 has been permitted (Yes in step S106), the input data reception unit 30 returns to step S101. That is, the input data reception unit 30 receives input data included in the next compressed stream 7 per compression unit and writes the input data to the shift register 31.

Through the first process described above, the input data reception unit 30 can control, for each compression unit, reception of the compressed stream 7 from the outside and writing the compressed stream 7 to the shift register 31. Specifically, the input data reception unit 30 can prohibit writing of new input data to the shift register 31 until the payload 41 of the final block in the compressed stream 7 per compression unit is transferred from the shift register 31 to the data buffer 35 after the compressed stream 7 per compression unit is stored up to its end in the shift register 31.

Note that the compressed stream 7 may include a plurality of compression units. In this case, the LAST signal 9 becomes “1” at the timing when transfer of the last compression unit among the plurality of compression units included in the compression stream 7 is completed. Step S103 of the first process described above is replaced with, for example, a step in which the input data reception unit 30 determines whether the compressed stream 7 including the plurality of compression units has been stored up to its end in the shift register 31 on the basis of the LAST signal 9.

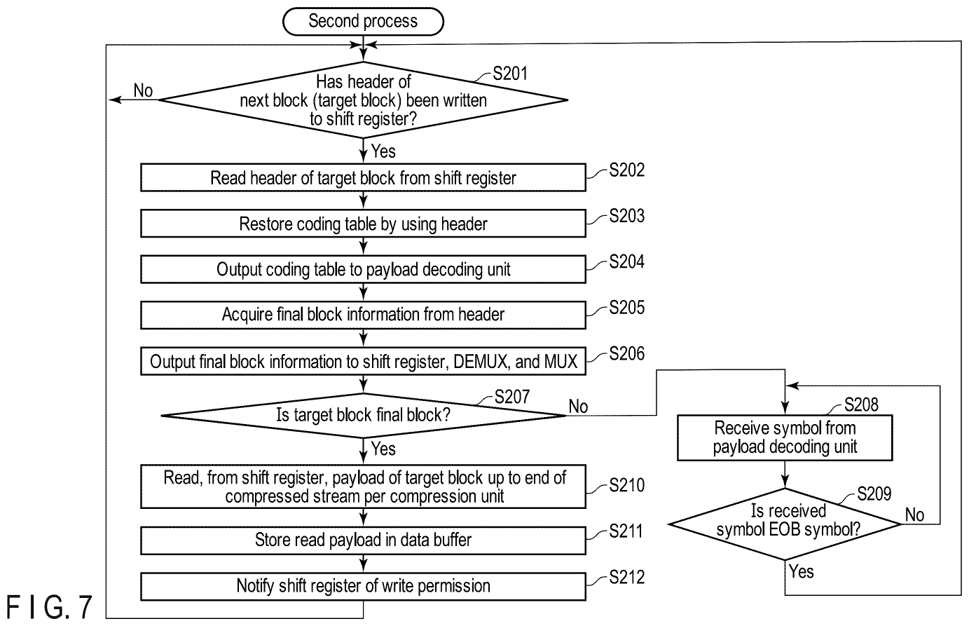

FIG. 7 is a flowchart illustrating an example of the procedure of a second process executed in the data decoding device 15. The second process is a process for decoding a header 40 for each block included in the compressed stream 7. The header decoding unit 32 and the DEMUX 33 execute the second process, for example, when at least a part of the compressed stream 7 per compression unit has been stored in the shift register 31 and has not been processed.

First, the header decoding unit 32 determines whether a header 40 of the next block (hereinafter, also referred to as a target block) has been written to the shift register 31 (step S201). The target block is either (A) in the current compressed stream 7 per compression unit, a block subsequent to a block corresponding to the coding table 42 that is most recently restored by the header decoding unit 32, or (B) the leading block in the next compressed stream 7 per compression unit subsequent to a compressed stream 7 per compression unit that includes the final block corresponding to the coding table 42 that is most recently restored by the header decoding unit 32. The header decoding unit 32 determines whether the header 40 of the target block has been written, for example, based on the amount of data stored in the shift register 31.

When the header 40 of the target block has not been written to the shift register 31 (No in step S201), the header decoding unit 32 returns to step S201. In other words, the header decoding unit 32 stands by until the header 40 of the target block is written to the shift register 31.

When the header 40 of the target block has been written to the shift register 31 (Yes in step S201), the header decoding unit 32 reads the header 40 of the target block from the shift register 31 (step S202). The header decoding unit 32 restores a coding table 42 corresponding to the target block by using the read header 40 (step S203). The header decoding unit 32 outputs the restored coding table 42 to the payload decoding unit 36 (step S204). The header decoding unit 32 (more specifically, the final block determination unit 321) acquires final block information 44 from the read header 40 (step S205). The header decoding unit 32 outputs the acquired final block information 44 to the shift register 31, the DEMUX 33, and the MUX 34 (step S206). Note the execution order of the process of steps S203 and S204 and the process of steps S205 and S206 may be interchanged, or these processes may be executed in parallel.

Next, by using the acquired final block information 44, the header decoding unit 32 determines whether the target block is the final block in the current compressed stream 7 per compression unit (step S207). For example, the final block information indicates “1” when the target block is the final block, and indicates “0” when the target block is not the final block. In this case, the header decoding unit 32 determines whether the final block information indicates “1” (final block) or “0” (non-final block).

When the target block is not the final block (No in step S207), the header decoding unit 32 receives a symbol from the payload decoding unit 36 (step S208). Then, the header decoding unit 32 determines whether the received symbol is an EOB symbol 45 (step S209).

When the received symbol is not an EOB symbol 45 (No in step S209), the header decoding unit 32 returns to step S208. That is, the header decoding unit 32 stands by until an EOB symbol 45 is received from the payload decoding unit 36.

When the received symbol is an EOB symbol 45 (Yes in step S209), the header decoding unit 32 returns to step S201. That is, since the EOB symbol 45 indicative of the end of the current block has been obtained by the payload decoding unit 36 decoding the payload 41, the header decoding unit 32 further performs a process for decoding a header 40 of the next block.

In addition, when the target block is the final block (Yes in step S207), the DEMUX 33 reads, from the shift register 31, data up to the end of the current compressed stream 7 per compression unit as the payload 41 of the target block (step S210). The DEMUX 33 stores the read payload 41 in the data buffer 35 (step S211). Then, the header decoding unit 32 notifies the shift register 31 of write permission (step S212), and returns to step S201. That is, since the payload 41 of the final block in the current compressed stream 7 per compression unit has been stored (saved) in the data buffer 35, the header decoding unit 32 notifies the shift register 31 of write permission. As a result, writing of the next compressed stream 7 per compression unit to the shift register 31 may be started. In addition, the header decoding unit 32 may start a process for decoding a header 40 of the leading block in the next compressed stream 7 per compression unit (i.e., the second process).

Through the second process described above, the header decoding unit 32 can decode a header 40 for each block included in the compressed stream 7, thereby acquiring the coding table 42 and the final block information 44. When the target block is the final block, the DEMUX 33 stores, in the data buffer 35, the payload 41 of the final block in the current compressed stream 7 per compression unit. This enables the next compressed stream 7 per compression unit to be written to the shift register 31. Therefore, in the data decoding device 15, for example, the decoding of the payload 41 of the final block in the current compressed stream 7 per compression unit and the decoding of the header 40 of the leading block in the next compressed stream 7 per compression unit can be executed in parallel at least partially.

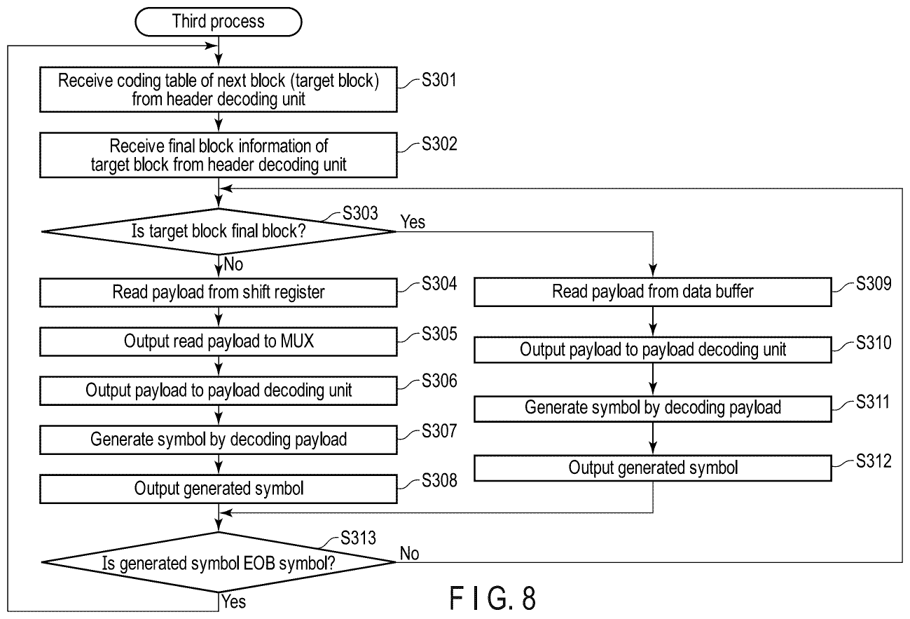

FIG. 8 is a flowchart illustrating an example of the procedure of a third process executed in the data decoding device 15. The third process is a process for decoding a payload 41 for each block included in the compressed stream 7. The payload decoding unit 36, the DEMUX 33, and the MUX 34 execute the third process, for example, in a case where at least a part of the compressed stream 7 per compression unit has been stored in the shift register 31 and has not been processed.

First, the payload decoding unit 36 receives a coding table 42 of the next block (target block) from the header decoding unit 32 (step S301). In addition, the payload decoding unit 36 receives final block information 44 from the header decoding unit 32 (step S302). Note that the execution order of the process of step S301 and the process of step S302 may be interchanged. By using the received final block information 44, the payload decoding unit 36 determines whether the target block is the final block in the current compressed stream 7 per compression unit (step S303).

When the target block is not the final block (No in step S303), the DEMUX 33 reads a payload 41 of the target block from the shift register 31 (step S304). The DEMUX 33 outputs the read payload 41 to the MUX 34 (step S305). The MUX 34 outputs, to the payload decoding unit 36, the payload 41 received from the DEMUX 33 (step S306). The payload decoding unit 36 decodes the payload 41 received from the MUX 34 by using the coding table 42, thereby generating a symbol (step S307). The payload decoding unit 36 outputs the generated symbol as decoded data 43 and outputs the generated symbol to the header decoding unit 32 (step S308), and proceeds to step S313.

On the other hand, when the target block is the final block (Yes in step S303), the MUX 34 reads a payload 41 of the target block (i.e., the final block) from the data buffer 35 (step S309). The MUX 34 outputs, to the payload decoding unit 36, the payload 41 read from the data buffer 35 (step S310). The payload decoding unit 36 decodes the payload 41 received from the MUX 34 by using the coding table 42, thereby generating a symbol (step S311). The payload decoding unit 36 outputs the generated symbol as decoded data 43 (step S312), and proceeds to step S313.

Next, the payload decoding unit 36 determines whether the generated symbol is an EOB symbol 45 (step S313).

When the generated symbol is not an EOB symbol 45 (No in step S313), the payload decoding unit 36 returns to step S303. That is, the payload decoding unit 36 continues a process for acquiring a payload 41 either from the shift register 31 via the DEMUX 33 and the MUX 34 or from the data buffer 35 via the MUX 34 and decoding the acquired payload 41.

When the generated symbol is an EOB symbol 45 (Yes in step S313), the payload decoding unit 36 returns to step S301. That is, the payload decoding unit 36 further performs a process for decoding a payload 41 of the next block. In this case, the next block is (A) a block subsequent to the target block in the current compressed stream 7 per compression unit when the target block is not the final block, and (B) the leading block in a compressed stream 7 per compression unit subsequent to the current compressed stream 7 per compression unit when the target block is the final block.

Through the third process described above, the payload decoding unit 36 can decode either the payload 41 acquired from the shift register 31 via the DEMUX 33 and the MUX 34 or the payload 41 acquired from the data buffer 35 via the MUX 34. The payload decoding unit 36 acquires the payload 41 of the final block in the compressed stream 7 per compression unit from the data buffer 35 rather than the shift register 31. This is because the payload 41 of the final block has been moved from the shift register 31 to the data buffer 35 in response to determination that the target block is the final block by the header decoding unit 32. This enables the next compressed stream 7 per compression unit to be written to the shift register 31. Then, in the data decoding device 15, for example, the decoding of the payload 41 of the final block in the current compressed stream 7 per compression unit (i.e., the payload 41 stored in the data buffer 35) and the decoding of the header 40 of the leading block in the next compressed stream 7 per compression unit (i.e., the header 40 stored in the shift register 31) can be executed at least partially in parallel. Therefore, the data decoding device 15 can improve the throughput of decoding the compressed stream 7.

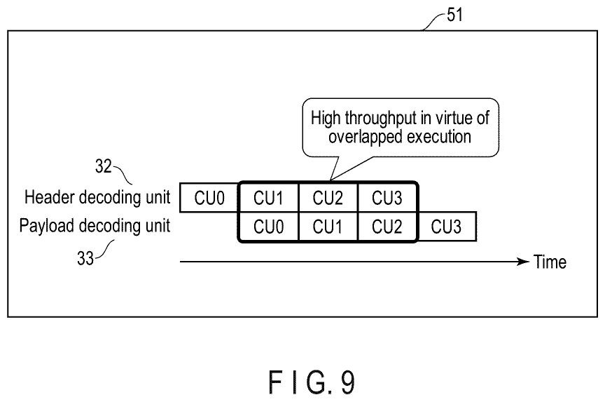

FIG. 9 is a timing chart illustrating an example of periods in which processes of decoding headers 40 are executed and periods in which processes of decoding payloads 41 are executed, in the data decoding device 15. In the timing chart 51, the horizontal axis indicates time. Here, it is assumed that a compressed stream 7 per compression unit includes one block. In the timing chart 51, a period in which a header 40 included in each compression unit is decoded by the header decoding unit 32 and a period in which a payload 41 included in each compression unit is decoded by the payload decoding unit 36 are illustrated along the passage of time.

In the data decoding device 15, decoding of a header 40 executed by the header decoding unit 32 and decoding of a payload 41 executed by the payload decoding unit 36 overlap at least partially. Specifically, in the data decoding device 15, after a header 40 included in a compression unit CU0 is decoded, execution of decoding a payload 41 included in the compression unit CU0 and execution of decoding a header 40 included in a compression unit CU1 overlap at least partially. Next, execution of decoding a payload 41 included in the compression unit CU1 and execution of decoding a header 40 included in a compression unit CU2 overlap at least partially. Then, execution of decoding a payload 41 included in the compression unit CU2 and execution of decoding a header 40 included in a compression unit CU3 overlap at least partially.

In other words, the header decoding unit 32 sequentially and continuously executes the process of decoding the header 40 included in the compression unit CU0, the header 40 included in the compression unit CU1, the header 40 included in the compression unit CU2, and the header 40 included in the compression unit CU3. In addition, the payload decoding unit 36 sequentially and continuously executes the process of decoding the payload 41 included in the compression unit CU0, the payload 41 included in the compression unit CU1, the payload 41 included in the compression unit CU2, and the payload 41 included in the compression unit CU3. Moreover, the process by the header decoding unit 32 and the process by the payload decoding unit 36 are executed at least partially in parallel. Note that a process of decoding a payload 41 belonging to a block (final block) included in a compression unit by the payload decoding unit 36 and a process of decoding a header 40 belonging to a block (leading block) included in the next compression unit by the header decoding unit 32 may start either one before the other or simultaneously. For example, the process of decoding the payload 41 belonging to the final block included in the compression unit by the payload decoding unit 36 starts prior to the process of decoding the header 40 belonging to the leading block included in the next compression unit by the header decoding unit 32.

In this manner, in the data decoding device 15, decoding a payload 41 included in a compression unit (e.g., decoding the payload 41 included in the compression unit CU0) and decoding a header 40 included in the next compression unit (e.g., decoding the header 40 included in the compression unit CU1) are executed in an overlapping time (that is, in parallel). As a result, the data decoding device 15 can improve the throughput of decoding (decompressing) the compressed stream 7 as compared with the throughput of decoding the compressed stream 7C by the data decoding device 15C of the comparative example.

As described above, according to the data decoding device 15 of the present embodiment, the throughput of data decoding can be improved.

The shift register 31 stores a first data stream (e.g., a compressed stream 7 per compression unit) that includes one or more first blocks each including a header 40 and a payload 41. The header decoding unit 32 decodes the header 40. The data buffer 35 is capable of storing the payload 41. The payload decoding unit 36 decodes the payload 41. The DEMUX 33 switches a transfer destination to which the payload 41 is transferred from the shift register 31. The MUX 34 switches a transfer source from which the payload 41 is transferred to the payload decoding unit 36. In a case where a second block among the one or more first blocks is the final block in a first data stream, the DEMUX 33 transfers the payload 41 included in the second block from the shift register 31 to the data buffer 35, and the MUX 34 transfers the payload 41 stored in the data buffer 35 to the payload decoding unit 36.

As a result, for example, the next second data stream (e.g., the next compressed stream 7 per compression unit) is written to the shift register 31. Then, in the data decoding device 15, for example, (A) execution of a process of decoding the payload 41 of the final block in the first data stream read from the data buffer 35 and (B) execution of a process of decoding the header 40 of the leading block in the second data stream read from the shift register 31 can overlap at least partially. Therefore, the data decoding device 15 can improve the throughput of decoding the compressed stream 7 as compared with the data decoding device 15C of the comparative example.

Each of the various functions described in the embodiment may be realized by a circuit (e.g., processing circuit). An exemplary processing circuit may be a programmed processor such as a central processing unit (CPU). The processor executes computer programs (instructions) stored in a memory thereby performs the described functions. The processor may be a microprocessor including an electric circuit. An exemplary processing circuit may be a digital signal processor (DSP), an application specific integrated circuit (ASIC), a microcontroller, a controller, or other electric circuit components. The components other than the CPU described according to the embodiment may be realized in a processing circuit.

While certain embodiments have been described, these embodiments have been presented by way of example only, and are not intended to limit the scope of the inventions. Indeed, the novel devices and methods described herein may be embodied in a variety of other forms; furthermore, various omissions, substitutions and changes in the form of the embodiments described herein may be made without departing from the spirit of the inventions. The accompanying claims and their equivalents are intended to cover such forms or modification as would fall within the scope and spirit of the inventions.

What is claimed is

1. A data decoding device comprising:
a first memory configured to store a first data stream that includes one or more first blocks each including a data portion of a first type and a data portion of a second type;
first decoding circuitry configured to decode the data portion of the first type;
a second memory capable of storing the data portion of the second type;
second decoding circuitry configured to decode the data portion of the second type;
first selection circuitry configured to switch a transfer destination to which the data portion of the second type is transferred from the first memory; and
second selection circuitry configured to switch a transfer source from which the data portion of the second type is transferred to the second decoding circuitry, wherein
in a case where a second block among the one or more first blocks is a final block in the first data stream,
the first selection circuitry is configured to transfer a second data portion of the second type included in the second block from the first memory to the second memory, and
the second selection circuitry is configured to transfer the second data portion stored in the second memory to the second decoding circuitry.

2. The data decoding device according to claim 1, wherein
in a case where the second block is the final block in the first data stream,
the first memory is configured to store a second data stream that includes one or more third blocks each including a data portion of the first type and a data portion of the second type, and
decoding of the second data portion included in the second block by the second decoding circuitry is performed in parallel with decoding of a data portion of the first type included in a leading block among the one or more third blocks by the first decoding circuitry.

3. The data decoding device according to claim 2, wherein
the first data stream and first information indicative of an end of the first data stream are input to the data decoding device, and then the second data stream is input to the data decoding device.

4. The data decoding device according to claim 3, further comprising
reception circuitry configured to receive the input first information and detect that data subsequently input to the data decoding device is the second data stream, based on the received first information.

5. The data decoding device according to claim 2, wherein
the first memory is configured to store the second data stream after the second data portion is transferred from the first memory to the second memory.

6. The data decoding device according to claim 2, wherein
each of the first data stream and the second data stream is a compressed stream that includes one or more compression units.

7. The data decoding device according to claim 6, wherein
the compressed stream is a compressed stream obtained by using entropy coding.

8. The data decoding device according to claim 1, wherein
a first data portion of the first type included in the second block includes second information that indicates whether the second block is the final block, and
the first decoding circuitry is configured to acquire the second information from the first data portion.

9. The data decoding device according to claim 8, wherein
the first decoding circuitry is configured to output the second information to the first selection circuitry and the second selection circuitry, and
in a case where the second information indicates that the second block is the final block,
the first selection circuitry is configured to transfer the second data portion included in the second block from the first memory to the second memory, and
the second selection circuitry is configured to transfer the second data portion stored in the second memory to the second decoding circuitry.

10. The data decoding device according to claim 9, wherein
the first selection circuitry and the second selection circuitry are configured to, in a case where the second information indicates that the second block is not the final block, transfer the second data portion included in the second block from the first memory to the second decoding circuitry.

11. The data decoding device according to claim 1, wherein
the first data stream is a compressed stream obtained by using entropy coding,
the first decoding circuitry is configured to restore a coding table that indicates correspondence between a plurality of symbols and a plurality of codes that are allocated to the plurality of symbols, respectively, by using a first data portion of the first type included in the second block, and
the second decoding circuitry is configured to convert each of one or more codes included in the second data portion into a symbol by using the coding table.

12. The data decoding device according to claim 11, wherein
the first decoding circuitry is configured to output the coding table to the second decoding circuitry, and
the second decoding circuitry is configured to receive the coding table from the first decoding circuitry, and receive the second data portion transferred from either the first memory or the second memory.

13. The data decoding device according to claim 11, wherein
the second decoding circuitry is configured to output the symbol to the first decoding circuitry, and
the first decoding circuitry is configured to, in a case where the second block is not the final block and the symbol is an end-of-block symbol indicative of an end of the first block, decode a data portion of the first type included in a fourth block subsequent to the second block.

14. The data decoding device according to claim 1, wherein
the first memory is a shift register, and
the second memory is a data buffer.

15. The data decoding device according to claim 1, further comprising
data reception circuitry configured to receive the first data stream and store the first data stream in the first memory, wherein
the data portion of the second type is input to the data reception unit subsequent to the data portion of the first type.

16. A memory system comprising:
a nonvolatile memory;
a random access memory; and
a controller configured to control the nonvolatile memory and the random access memory, and comprising a data decoding device comprising:
a first memory configured to store a first data stream that includes one or more first blocks each including a data portion of a first type and a data portion of a second type;
first decoding circuitry configured to decode the data portion of the first type;
a second memory capable of storing the data portion of the second type;
second decoding circuitry configured to decode the data portion of the second type;
first selection circuitry configured to switch a transfer destination to which the data portion of the second type is transferred from the first memory; and
second selection circuitry configured to switch a transfer source from which the data portion of the second type is transferred to the second decoding circuitry, wherein
the controller is configured to:
read the first data stream from the nonvolatile memory;
store the read first data stream in the random access memory; and
input the first data stream stored in the random access memory to the data decoding device, and
in case where a second block among the one or more first blocks is a final block in the first data stream,
the first selection circuitry is configured to transfer a second data portion of the second type included in the second block from the first memory to the second memory, and
the second selection circuitry is configured to transfer the second data portion stored in the second memory to the second decoding circuitry.

17. The memory system according to claim 16, wherein
in a case where the second block is the final block in the first data stream,
the first memory is configured to store a second data stream that includes one or more third blocks each including a data portion of the first type and a data portion of the second type, and
decoding of the second data portion included in the second block by the second decoding circuitry is performed in parallel with decoding of a data portion of the first type included in a leading block among the one or more third blocks by the first decoding circuitry.

18. The memory system according to claim 17, wherein
the controller is configured to, after inputting the first data stream and first information indicative of an end of the first data stream to the data decoding device, input the second data stream to the data decoding device.

19. The memory system according to claim 16, wherein
a first data portion of the first type included in the second block includes second information that indicates whether the second block is the final block, and
the first decoding circuitry is configured to acquire the second information from the first data portion.

20. The memory system according to claim 19, wherein
the first decoding circuitry is configured to output the second information to the first selection circuitry and the second selection circuitry, and
in a case where the second information indicates that the second block is the final block,
the first selection circuitry is configured to transfer the second data portion included in the second block from the first memory to the second memory, and
the second selection circuitry is configured to transfer the second data portion stored in the second memory to the second decoding circuitry.
